(19) United States
(12) Patent Application Publication
(10) Pub. No.: US 2026/0205728 A1
(43) Pub. Date: Jul. 16, 2026

(54) COMPUTERIZED SYSTEM FOR MAKING A CUSTOMIZED EARPIECE

(71) Applicant: Wavs Custom, Inc., Greenville, SC (US)

(72) Inventor: Charles Richard Hoke, Greenville, SC (US)

(73) Assignee: Wavs Custom, Inc., Greenville, SC (US)

(21) Appl. No.: 19/548,010

(22) Filed: Feb. 24, 2026

Related U.S. Application Data
(63) Continuation-in-part of application No. 18/735,751, filed on Jun. 6, 2024, now Pat. No. 12,593,161.
Application No. 18/735,751 is a continuation of application No. 17/230,170, filed on Apr. 14, 2021, now Pat. No. 12,382,211.
(60) Provisional application No. 63/009,526, filed on Apr. 14, 2020.

(51) Int. Cl. H04R 1/10; G06V 40/16

(52) U.S. Cl. CPC H04R 1/1058; G06V 40/166; G06V 40/172; H04R 1/1016; H04R 2201/105

(57) ABSTRACT

A system for making a customized earpiece comprises an electronic device including at least one camera system configured to perform three-dimensional mapping image scans, a server in communication with the electronic device, and a three-dimensional printer connected to the server. The system creates a unique identifier associated with a user, scans an ear of the user with the electronic device, associates the unique identifier with one or more scans, receives the scans and earpiece parameters at a database via transmission from the electronic device, and forms, via the three-dimensional printer, a mold having an internal configuration corresponding to the scans and earpiece parameters. The mold is utilized to create a custom-fit earpiece with customized internal components matching the user-provided earpiece parameters.

### RELATED APPLICATIONS

This application is a continuation in part of U.S. Nonprovisional Application No. Ser. No. 18/735,751, which is a continuation of U.S. Nonprovisional Application No. Ser. No. 17/230,170 filed on Apr. 14, 2021, which claims priority from U.S. Provisional Ser. No. 63/009,526 filed on Apr. 14, 2020. The above patent applications are incorporated by reference.

### BACKGROUND OF THE INVENTION

### 1) Field of the Invention

The present invention relates to a computerized system and method for making customized in-the-ear equipment, also called earpieces, and more particularly, a system for making a custom-fit molded earpiece that can be customized to provide hearing protection and in-the-ear audio for the user.

### 2) Description of the Related Art

In-the-ear equipment, including ear buds and earplugs, is commonly used in several industries and applications. Many activities require proper hearing protection that fits within the ear in order to protect the wearer from inner ear damage or hearing loss. Currently, the two main styles of ear protection are foam earplugs that are placed within one's ear or larger earmuffs. Both current forms of hearing protection have drawbacks. The large earmuffs tend to be bulky, difficult to properly wear, and unsightly. Their large size and bulk lead to them being difficult to wear during various activities. Even modern ear protection devices having systems for amplifying quieter sounds while blocking louder sounds have this issue of being difficult to transport and wear comfortably, due to their added size and weight. in-the-ear foam earplugs have their own drawbacks. Many are typically a single size. While some are marketed to mold to the shape of the ear, the “one size fits all” nature of the earplug means that some user's will have difficult fitting them to their ear, as the shape and size of the ear opening can vary greatly between individuals. These foam ear plugs tend to be difficult to keep in place and tend to fall from one's ears if not constantly adjusted. Due to the above issues, some individuals will forgo using any ear protection, which can lead to hearing loss or other damage in some situations.

Another in-the-ear device is an earbud having a speaker that is operably connected to an audio source via a wired or wireless connection. The earbud is a common means for listening to audio that many individuals prefer over bulkier headphones that fit over the ears. However, these earbuds are also typically a single-sized item that cannot adjust to different sized ears. These earbuds often fall from the wearer's ears, becoming lost or damaged due to the poor, nonadjustable fit. Some earbuds include tips that can be attached and detached to change the size of the earbud, but these tips are often easy to misplace and difficult to secure to the earbud.

It is therefore an object of the present invention to provide a computerized system for making a customized earpiece having user-selected materials and drivers.

It is another object of the present invention to provide a computerized system for making a customized earpiece having user-selected materials and drivers.

### SUMMARY OF THE INVENTION

The present invention provides a computerized system and method for making customized earpieces. The user can utilize an electronic device having the appropriate dimension capture component, such as a camera, to scan and image their own ears. The resulting data can be utilized to make a custom-fit earpiece molded to fit the user's ears. The earpieces can be further customized to have various properties or internal components, such as speaker drivers.

In light of the disadvantages of earpieces and other related devices in the known art, it is submitted that the present invention substantially diverges in design elements from the known art and consequently it is clear that there is a need in the art for an improvement to existing earbud devices with regard to user customization. In this regard, the present invention substantially fulfills these needs.

The system comprises an electronic device including at least one camera system configured to perform three-dimensional mapping image scans, a server in communication with the electronic device, and a three-dimensional printer connected to the server. The system and method for making a customized earpiece includes creating a unique identifier associated with a user, scanning an ear of the user with the electronic device, associating the unique identifier with one or more scans obtained via the electronic device, receiving, at a database, the one or more scans via transmission from the electronic device, receiving, at the database, one or more earpiece parameters via transmission from the electronic device, and forming, via the three-dimensional printer, a mold having an internal configuration corresponding to the one or more scans and the one or more earpiece parameters.

The above objectives are accomplished by providing a system for making a customized earpiece comprising a server adapted to provide a remote service data to a user, wherein the remote service data is adapted to scan an ear, an electronic device in communications with the server, a three-dimensional printer in communications with the server, a database of pre-existing molds in communications with the server, and a set of server computer readable instructions configured to receive a scan of the ear wherein the scan includes dimensions of the ear, receive an earpiece parameter according to the dimensions of the ear, receive a speaker driver parameter representing a speaker driver, select from the database of pre-existing molds a specific mold according to a fit score, transmit the selected mold to the electronic device for verification from the user to use the mold, and upon receiving validation, transmit to a manufacturing machine, wherein the manufacturing machine is adapted to create an earpiece.

According to other aspects of the present disclosure, the system may include one or more of the following features. The set of server computer readable instructions may be further configured to suggest to a server user a modification in the database of pre-existing molds for adding a new mold configuration when the fit score for a plurality of users fails to select below a threshold value for existing molds in the database. The set of server computer readable instructions may be further configured to remove a specific mold from the database of pre-existing molds when the specific mold has not been selected over a threshold period of time. The fit score may be calculated by comparing the dimensions of the ear from the scan against dimensional characteristics of each mold in the database of pre-existing molds. The earpiece parameter may include at least one of a material type, an earpiece style, and an intended use environment. The set of server computer readable instructions may be further configured to suggest an alternative speaker driver based upon the dimensions of the ear and the intended use environment specified in the earpiece parameter.

According to another aspect of the present disclosure, a system for making a customized earpiece is provided. The system comprises a server adapted to provide a remote service data to a user, wherein the remote service data is adapted to scan an ear, an electronic device in communications with the server, a three-dimensional printer in communications with the server, and a set of server computer readable instructions configured to receive a scan of the ear wherein the scan includes of the ear, receive an earpiece parameter according to the dimensions of the ear, receive a speaker driver parameter representing a speaker driver, associate the scan, the earpiece parameter, and the speaker driver parameter with each other, generate a print parameter based on the scan, the earpiece parameter, and the speaker driver parameter, and transmit the print parameter to a manufacturing machine, wherein the manufacturing machine is adapted to create a mold according to the scan, the earpiece parameter, and the speaker driver parameter.

According to other aspects of the present disclosure, the system may include one or more of the following features. A resulting earpiece may be derived from the mold and may include a cavity for receiving a speaker driver. The manufacturing machine may be a three-dimensional printer. The three-dimensional printer may be a stereolithography (SLA) printer, a selective laser sintering (SLS) printer, a fused deposition modeling (FDM) printer, a digital light processing (DLP) printer, or a multi-jet fusion (MJF) printer. SLA printers utilize a laser to cure liquid photopolymer resin layer by layer and may be suitable for producing earpiece molds with smooth surface finishes and fine detail resolution. SLS printers use a laser to sinter powdered material and may be advantageous for producing durable molds from nylon or other thermoplastic powders. DLP printers project an entire layer image simultaneously using a digital projector and may provide faster print times compared to SLA for certain mold geometries. FDM printers extrude thermoplastic filament through a heated nozzle and may be suitable for producing prototype molds or molds from flexible materials. MJF printers utilize an inkjet array to selectively apply fusing agents to powdered material and may be suitable for high-volume production of earpiece molds with consistent mechanical properties.

The electronic device may be adapted to utilize structured light scanning to capture the dimensions of the ear. The scan may be provided by scanning computer readable instructions downloaded from the server to the electronic device. The web application may be accessed from the electronic device. The server, upon receiving the scan, the earpiece parameter and the speaker driver parameter, may be adapted to suggest an alternative speaker driver according to a usage data included in the earpiece parameter.

According to another aspect of the present disclosure, a system for making a customized earpiece is provided. The system comprises a server adapted to provide remote service data to a user, an electronic device in communications with the server, a manufacturing machine in communications with the server, and a set of server computer readable instructions configured to receive a scan of an ear wherein the scan includes dimensions of the ear, receive an earpiece parameter, receive a speaker driver parameter representing a speaker driver, and transmit data to the manufacturing machine, wherein the manufacturing machine is adapted to select an earpiece mold from a database of pre-existing molds according to a fit score or create an earpiece mold according to the scan, the earpiece parameter, and the speaker driver parameter.

According to other aspects of the present disclosure, the system may include one or more of the following features. The fit score may be calculated by comparing the dimensions of the ear from the scan against dimensional characteristics of each mold in the database of pre-existing molds. The set of server computer readable instructions may be further configured to provide feedback to a user via the electronic device regarding quality and completeness of the scan. The earpiece parameter may include an intended use environment selected from industrial settings, office environments, outdoor recreational activities, musical performance venues, or quiet indoor listening environments. The set of server computer readable instructions may be further configured to filter available speaker drivers based upon physical dimensions of the ear captured in the scan to identify drivers that fit within dimensional constraints of the earpiece mold.

According to another aspect of the present disclosure, a system for making a customized earpiece is provided. The system comprises a server adapted to provide service data to an electronic device in communications with the server, a manufacturing machine in communications with the server, and a set of server computer readable instructions configured to receive a scan of an ear, receive an earpiece parameter, receive a speaker driver parameter, associate the scan, the earpiece parameter, and the speaker driver parameter, and transmit data to the manufacturing machine to create an earpiece according to the scan, the earpiece parameter, and the speaker driver parameter.

According to other aspects of the present disclosure, the earpiece parameter may include at least one of a material type, an earpiece style, color, and an intended use environment.

### BRIEF DESCRIPTION OF THE DRAWINGS

The construction designed to carry out the invention will hereinafter be described, together with other features thereof. Other objects, features and advantages of the present invention will become apparent from the following detailed description taken in conjunction with the accompanying drawings. The invention will be more readily understood from a reading of the following specification and by reference to the accompanying drawings forming a part thereof, wherein an example of the invention is shown and wherein:

FIG. 1 is a schematic diagram of aspects of the computerized system for making a customized earpiece;

FIG. 2 is a flowchart of aspects of the method for making a customized earpiece; and

FIG. 3 is a schematic diagram of aspects of the computerized system for making a customized earpiece.

While each of the drawing figures depicts a particular embodiment for purposes of depicting a clear example, other embodiments may omit, add to, reorder, and/or modify any of the elements shown in the drawing figures. For purposes of depicting clear examples, one or more figures may be described with reference to one or more other figures, but using the particular arrangement depicted in the one or more other figures is not required in other embodiments. The drawings and schematic representations are intended to support the understanding of the invention. These may not be to scale and are not intended to limit the invention to any particular layout, connectivity, or architectural implementation. Correspondence between drawing elements and described components is provided for illustrative purposes and should not be interpreted to limit the claim scope.

### DETAILED DESCRIPTION OF THE INVENTION

Reference is made herein to the attached drawings. Like reference numerals are used throughout the drawings to depict like or similar elements of the method for making a customized earpiece. For the purposes of presenting a brief and clear description of the present invention, the preferred embodiment will be discussed as used for providing a system and method for making a customized earpiece that includes a size determined by a three-dimensional scan of the user's ear and that includes interior components selected by the user. The figures are intended for representative purposes only and should not be considered to be limiting in any respect.

According to some embodiments, the operations, techniques, and/or components described herein can be implemented as (i) a special-purpose computing device having specialized hardware and a logic hardwired into the computing device to persistently perform the disclosed operations and/or techniques or (ii) a logic that is implementable on an electronic device having a general purpose hardware processor to execute the logic and a computer-readable medium, e.g. a memory, wherein implementation of the logic by the processor on the electronic device provides the electronic device with the function of a special-purpose computing device.

As referred to herein, the term “electronic device” refers to any computing device that includes at least a display screen and an input mechanism. The computing devices can be hard-wired to perform the operations, techniques, and/or components described herein, or can include digital electronic devices such as one or more application-specific integrated circuits (ASICs) or field programmable gate arrays (FPGAs) that are persistently programmed to perform the operations, techniques and/or components described herein, or can include one or more general purpose hardware processors programmed to perform such features of the present disclosure pursuant to program instructions in firmware, memory, other storage, or a combination. Such computing devices can also combine custom hard-wired logic, ASICs, or FPGAs with custom programming to accomplish the technique and other features of the present disclosure. The computing devices can be desktop computer systems, laptops, cell phones, tablets, networking devices, or any other device that incorporates hard-wired and/or program logic to implement the techniques and other features of the present disclosure.

In the interests of economy, the present disclosure refers to “a computer-readable medium,” “a processor,” and so on. However, this should not be read as limiting in any way as the present disclosure contemplates embodiments of the present invention utilizing “one or more computer-readable media,” “one or more processors,” and so on. Unless specifically limited to a single unit, “a” is intended to be equivalent to “one or more” throughout the present disclosure.

As used herein, the term “earpiece” refers to any in-the-ear type device, including but not limited to earbuds, earphones, in-the-ear monitors, earplugs, hearing aids, wireless earbuds, Bluetooth earpieces, communication earpieces, in-the-ear receivers, noise-canceling earpieces, musician's earplugs, swimmer's earplugs, custom ear molds, sleep earplugs, and any other similar device. The present invention provides for the creation of molds for any suitable “earpiece” or in-the-ear type device as desired.

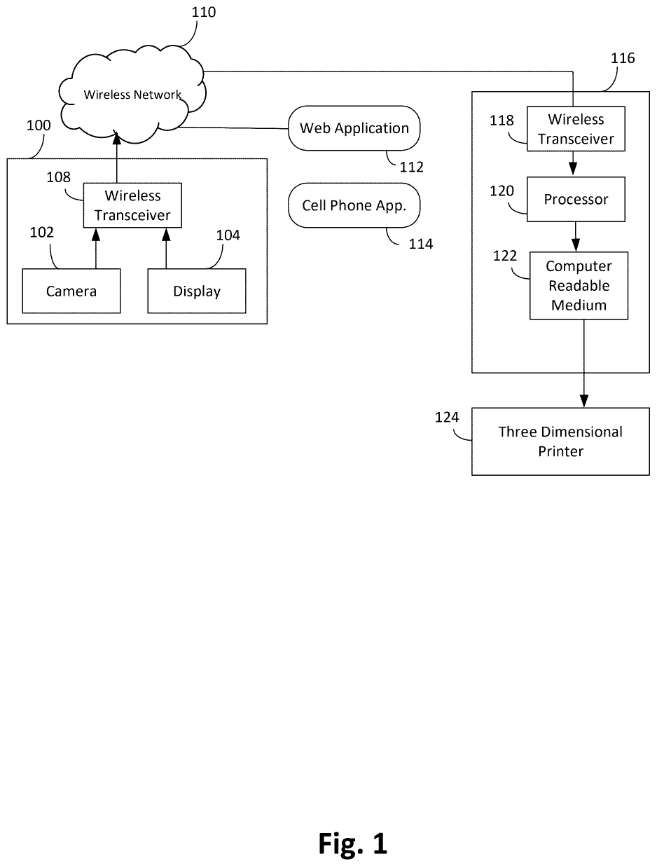

Referring now to FIG. 1, there is shown a schematic diagram of the components of various systems utilized in the method for making a customized earpiece. The system is utilized in concert to perform a method for making a customized earpiece. The system includes an electronic device 100 comprising at least a dimension capture device, such as a camera 102, a display 104, and a wireless transceiver 108. In one embodiment, electronic device 100 can utilize structured light scanning to capture the dimensions of the ear. Structured light scanning projects a known pattern of light onto the ear surface and analyzes the deformation of the pattern to calculate precise three-dimensional measurements. The dimension can be captured using projected infrared dots to capture the ruling pattern. In some embodiments, the electronic device 100 can utilize LiDAR (Light Detection and Ranging) scanning as an alternative to structured light scanning. LiDAR scanning emits laser pulses toward the ear surface and measures the time required for each pulse to reflect back to the sensor, enabling the calculation of precise distance measurements that can be used to generate a three-dimensional point map of the ear.

In some embodiments, the electronic device 100 may utilize photogrammetry as a scanning method to capture the dimensions of the ear. Photogrammetry may be used alone or in combination with other scanning methods described herein. In one implementation, photogrammetry may operate by capturing video of the ear and converting the video frames into a three-dimensional scan of the ear surface. The video-based approach allows the user to move the electronic device 100 around the ear while recording, and the system processes the captured frames to reconstruct the three-dimensional geometry. In some embodiments, photogrammetry may be paired with LiDAR scanning to provide enhanced dimension information. When combined with LiDAR, the photogrammetry data may be used to supplement the LiDAR point cloud with additional surface detail and texture information, resulting in a more complete and accurate three-dimensional representation of the ear.

In one embodiment, the electronic device 100 is a mobile phone, such as a smartphone, for example. The camera 102 of the electronic device is configured to record an image to generate a three-dimensional point map *e.g., structured light scanning) of an object within the recorded area. The electronic device 100 includes internal processors and software that can generate the point map from the recorded image. These systems typically include a dot projector that projects a grid of small infrared dots onto a user's face, a flood illuminator that shines infrared light at the face, and an infrared camera which takes an infrared picture of an object, reads the resulting pattern and generates a three-dimensional point map. The three-dimensional point map determines the ultimate size and appearance of an earpiece mold created by the system.

The wireless transceiver 108 is in wireless communication with a wireless network 110, such as the internet, for example. A server 116 can include its own wired or wireless transceiver 118 that is also in wireless communication with the wireless network 110, such that the server 116 can receive information from the electronic device 100. The system may also be accessible via cell phone applications 114 or web applications 112. The web applications 112 can be accessible via the electronic device's web browser and the cell phone applications can be installed directly on the electronic device 100.

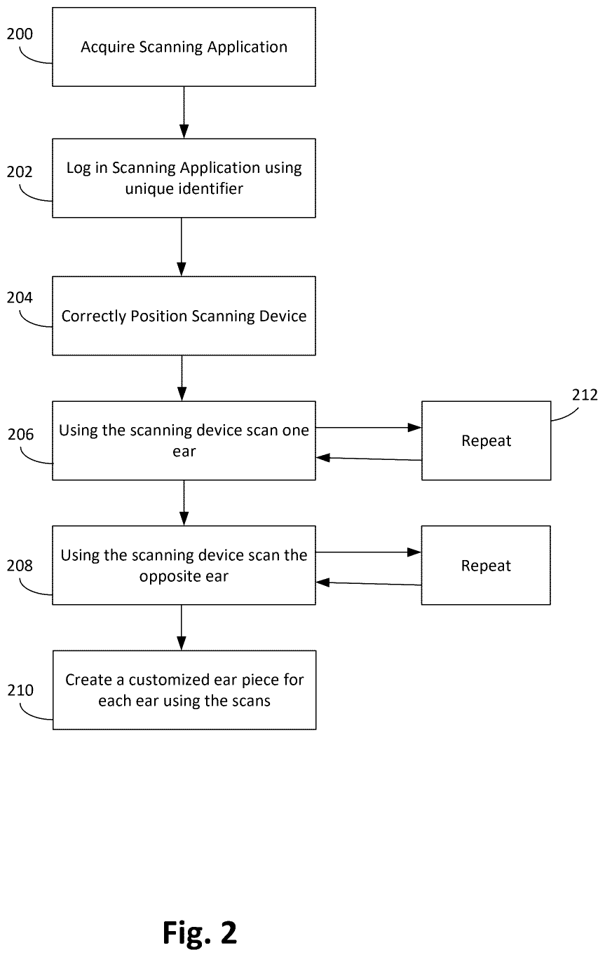

The server 116 includes a processor 120 and a non-transitory computer readable medium 122 operably connected to the processor 120, such as a memory, for example. A logic is stored on the non-transitory computer readable medium that, when executed by the processor, performs the method for making a customizable earpiece. The system can include receiving, via the wireless transceiver of the electronic device, a three-dimensional point map of an ear recorded by the one or more cameras of the electronic device, wherein the three-dimensional point map includes a unique identifier for matching the map to a particular user of the electronic device. The unique identifier can be in the form of a user profile or user ID number provided to the user from the database or via the web or cell phone application. The three-dimensional point map is received via a scan that is detailed in the discussion of FIG. 2 below.

The system can include receiving, via the wireless transceiver of the electronic device, one or more earpiece parameters. The user will have the ability to customize the components of the earpiece. For example, the user may select particular types and sizes of speaker drivers. The users may also select particular materials for their earpiece. This allows users to customize the exact functional components to suit their needs.

The service can include computer logic configured to calculating a mold size as determined by the dimensions of the three-dimensional point map and the one or more earpiece parameters. For example, mold sizes will vary for different sizes of ears and for different sizes of included speaker drivers. The mold size determination is embodied in an instruction file including print parameter data that is readable by a three-dimensional printer 124. The system accommodates various types and styles of printing devices that are capable of making a three-dimensional mold based on programmed instructions. In this way, the system can provide the specific instruction file to the three-dimensional printer, which then prints the mold for the earpiece. The mold can then be utilized to create the actual working earpiece, including specific materials and components as selected by the user.

In some embodiments, the system can transmit the print parameter data to a bank of three-dimensional printers arranged in a bulk assembly configuration. The server 116 can directly manage a plurality of three-dimensional printers 124 that are networked together and configured to operate in a coordinated manner, or can send information to an external three-dimensional printer server or system. The print projects can be distributed across the bank of printers based on printer availability, current workload, and printer capabilities. The assembly line configuration enables parallel processing of multiple earpiece orders simultaneously. The server 116 can maintain a queue of print jobs and allocate each job to an available printer within the bank. When a printer completes its assigned task, the server can automatically assigns the next job in the queue to that printer. The system can also implement load balancing algorithms that distribute print jobs evenly across the printer bank to maximize throughput and minimize production time. In some embodiments, the assembly line configuration includes conveyor systems or robotic handling mechanisms that transport partially completed molds between printers in the bank. A first printer in the sequence can produce a base component of the earpiece mold, which is then transported to a second printer that adds additional features or layers to the mold. This sequential processing approach allows for complex multi-material or multi-component earpiece molds to be produced efficiently. The server 116 coordinates the timing and sequencing of print jobs across the printer bank to ensure that components arrive at each station in the proper order and at the appropriate time.

Referring now to FIG. 2, there is shown a flowchart detailing the steps of an embodiment of the method for making a customized earpiece. Before beginning the scanning process, the system creates the unique identifier associated with a project and/or user. The user can then acquire a software application at 200 via either the database or some other source, which in conjunction with the camera of the electronic device is utilized to perform the three-dimensional scan. The user can utilize their unique identifier at 202 to access or log in to the scanning application.

In one embodiment, user verification is not required to log in to the scanning application. The user can perform the scanning process without an initial authentication step and instead transmits the scan data along with their user ID after completing the scan of each ear. This approach allows the user to complete the scanning process, transmit the scan data with the associated user ID to the server 116, and then repeat the process for the opposite ear. The server 116 receives each scan transmission and associates the scan data with the corresponding user ID to maintain proper linkage between the user and their ear dimension data. The user ID can be a job number, order number, or similar non-personally identifying identifier rather than a personally identifying ID, allowing the system to track and associate scan data with specific earpiece orders without requiring personal user information.

The user must then position the scanning device at 204, since the method includes scanning an ear of the user with an electronic device that includes at least one camera system that is configured to record a scan comprising a three-dimensional point map. In one embodiment, this step includes positioning the electronic device a threshold distance from the ear. The threshold distance should include a starting position equal to or less than eight inches from the ear, which was determined to be optimal for achieving a detailed and accurate scan. The camera for the electronic device is ideally positioned on the front side of the device that includes the display screen. This allows the user to view their scanned images to verify that they are scanning the ear correctly.

In one embodiment, the electronic device 100 can analyze the scan in real-time and provide feedback to the user regarding the quality and completeness of the captured data. The electronic device 100 can detect incorrect or improper usage, such as holding the device at an incorrect angle, positioning the device too far from or too close to the ear, or moving the device too quickly during the scanning process. When the electronic device 100 identifies such issues, the system can instruct the user to correct the improper usage by displaying guidance on the display 104, providing haptic feedback, visual indicators showing the correct positioning, audio prompts directing the user to adjust their technique, or text instructions explaining the necessary corrections. If the captured scan data is determined to be insufficient or of poor quality, the system can prompt the user to rescan the ear to obtain a more accurate scan.

The electronic device can be utilized to scan one ear of the user at 206. The scan can include moving the camera slowly around the area of the ear to record a complete dimension data set, such as a complete image of the ear and its interior. In some embodiments of the method, this step is repeated, such as at 212, as more scans can generate a more accurate scan that can, in one embodiment, result in a more accurate three-dimensional point map. In one embodiment, the scanning step may be performed within a threshold time of between fifteen and twenty seconds. This amount of time during the scan can ensure that a complete and accurate scan is achieved. This step can be repeated for the opposite ear at 208 and 214 in a similar manner, allowing the user to customize earpieces for both ears.

Utilizing the dimension scan information, a customized earpiece is created at 210. The unique identifier is associated with the particular scans so that they are matched to the user. The method further includes receiving, at the server, the one or more scans via transmission from the electronic device; and receiving, at the server, one or more earpiece parameters via transmission from the electronic device. The parameters include types of earpieces, including earplugs and earbuds, types of internal components such as speaker drivers, and types of materials, such as foam or plastic. All of the materials and components can vary as additional internal components and material types are contemplated, and the present invention is not intended to be limited to particular materials or electronic earpiece components that are included. However, the system provides the user with the option to customize these parameters. Coupled with the dimension scan (e.g., a three-dimensional point map) determining the precise size for the earpiece, the method then includes forming, via a three-dimensional printer, a mold having an internal configuration corresponding to the scan dimensions and the one or more earpiece parameters. The three-dimensional printer receives instructions create the mold. The resulting mold can then be utilized to make an earpiece from the desired material for the user. The earpiece can then be filled with speaker drivers and other components if applicable to the user's selections.

In some embodiments, the scanned parameter data may include geometric and acoustic characteristics of the user's ear. Geometric parameters may include ear canal length, canal diameter at multiple axial positions, canal curvature, cross-sectional shape, and canal volume. Additional geometric parameters may include concha bowl depth and width, relative positioning of the tragus and antitragus, and insertion depth of the earpiece within the ear canal. In some implementations, acoustic-related dimensions such as residual ear canal volume after insertion, vent diameter and vent length, and distance between a sound outlet and the tympanic membrane may also be captured. These parameters may be used individually or in combination to generate a customized earpiece geometry that improves fit, retention, comfort, and acoustic performance.

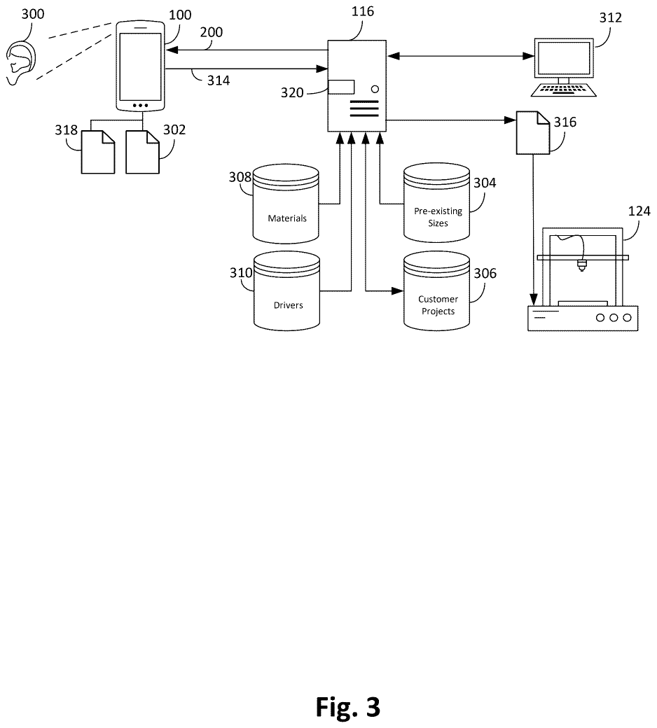

Referring now to FIG. 3, there is shown a schematic diagram of aspects of the computerized system for making a customized earpiece. The system includes a user 300 who interacts with an electronic device 100 to initiate and perform the earpiece customization process. The electronic device 100 is configured to capture scanned parameter data 302, which comprises the three-dimensional scan information of the user's ear obtained through the camera system of the electronic device 100. The electronic device 100 may store user files 318 that are associated with the user 300, including previously saved scans, user preferences, and account information.

The system can include a server 116 having a server interface 320 that facilitates communication between the various components of the system. The server 116 is in communication with the electronic device 100 via data transmission 200, enabling the transfer of scan data and user selections between the electronic device 100 and the server 116. The server 116 provides service enabling data 314 to the electronic device 100, which enables the electronic device 100 to run applications that provide the functionality necessary for scanning the user's ear and customizing earpiece parameters.

The server 116 can be connected to multiple databases that store information relevant to the earpiece customization process. A materials database 308 stores information regarding available materials for earpiece construction, such as foam, silicone, plastic, and other suitable materials.

A drivers database 310 stores information regarding speaker driver options, including various types, sizes, and specifications of speaker drivers that can be incorporated into the earpiece. The drivers database can include driver specifications such as frequency response range, impedance ratings, sensitivity levels, driver diameter, and driver depth measurements. The database can also store information regarding driver types, including balanced armature drivers, dynamic drivers, planar magnetic drivers, and hybrid driver configurations that combine multiple driver technologies. Each driver entry in the database can include compatibility data indicating which earpiece styles and sizes can accommodate the particular driver, as well as acoustic performance characteristics that allow the system to recommend drivers based on the user's intended use case.

A pre-existing sizes database 304 stores a pre-existing set of earpiece dimensions, including common shapes and sizes that can serve as templates or starting points for customization. The pre-existing sizes database 304 can be populated with dimensions derived from aggregated user data, wherein the most common ear dimensions across the user population are analyzed to establish the pre-existing mold configurations. In some embodiments, the pre-existing sizes database 304 may include a defined number of sizes along one dimension, such as ten sizes, with variations of other dimensions providing multiples of preselected sizes for use by the system. The server 116 can process historical scan data from the customer projects database 306 to identify frequently occurring dimensional patterns and generate template sizes that accommodate a significant portion of users without requiring fully custom molds.

A customer projects database 306 stores project data associated with individual users, including saved scans, previous orders, and ongoing customization projects. The customer projects database 306 enables the system to provide enhanced services for returning users by leveraging their historical data. When a user initiates a new earpiece order, the server 116 can retrieve previous scan data from the customer projects database 306 to offer the user the option of reusing an existing scan rather than performing a new scan. The system can also analyze a user's order history to identify patterns in material preferences, driver selections, and earpiece styles, allowing the server interface 320 to present personalized recommendations that align with the user's demonstrated preferences. Additionally, the customer projects database 306 facilitates reordering functionality, wherein a user can request a duplicate or modified version of a previously ordered earpiece without repeating the entire customization process. The stored project data can also be used to track changes in a user's ear dimensions over time if the user submits multiple scans across different sessions, enabling the system to alert the user if significant dimensional changes are detected that might affect the fit of previously ordered earpieces.

In one embodiment, the earpiece can include a power source such as a battery and a wireless communication chip. The battery can be a rechargeable lithium-ion or lithium-polymer battery sized to fit within the customized earpiece mold while providing sufficient power for the speaker drivers and wireless communication components. The wireless communication chip enables wireless connectivity between the earpiece and external audio sources such as smartphones, tablets, amplification systems, or other wirelessly-enabled devices. The wireless communication chip may utilize Bluetooth technology, near-field communication (NFC), proprietary wireless protocols, or other short-range wireless standards such as Bluetooth Low Energy (BLE), Wi-Fi Direct, or infrared communication. In some embodiments, the wireless communication chip may support multiple wireless protocols to provide compatibility with a broader range of external devices. The system can accommodate the power source and wireless communication chip within the earpiece design by incorporating appropriate cavities and routing channels into the mold specifications based on the user's ear dimensions and the physical dimensions of the selected electronic components.

The server can include a service enabling data 320 that allows the functionality of the remote devices to be provided. The service can receive scanned parameter data 302 from the electronic device 100 and retrieve relevant information from the materials database 308, drivers database 310, pre-existing sizes database 304, and customer projects database 306. Based on the scanned parameter data 302 and user selections from the various databases, the server 116 generates print parameter data 316. The print parameter data 316 comprises the instruction file that specifies the dimensions, configuration, and features of the earpiece mold to be printed.

A remote terminal 312 provides an alternative access point to the server 116 and can be used by system administrators or users to access the system via web applications. The remote terminal 312 enables management of databases, monitoring of system operations, and alternative user access to customization features. In some embodiments, a person trained in three-dimensional modeling can access the system, such as with the remote terminal 312 to review, edit, or modify the scanned parameter data 302 after the scans are received and before the print parameter data 316 is transmitted to the three-dimensional printer 124. This allows for manual adjustments to the scan data to correct any artifacts, refine dimensional accuracy, or accommodate special customization requests from the user.

The system can analyze the manual edits performed by the trained personnel to identify patterns in the types of corrections and modifications that are commonly applied to the scanned parameter data 302. Over time, the server 116 can learn from these manual inputs by tracking the nature and frequency of adjustments made to scan data across multiple user projects. The server interface 320 can apply machine learning techniques to correlate characteristics of the original scan data with the subsequent manual corrections, enabling the system to predict when similar corrections may be needed for new scans. As the system accumulates sufficient training data from manual editing sessions, the server 116 can begin to automate portions of the correction process by automatically applying learned adjustments to incoming scan data before human review. The automation can progress incrementally, with the system initially suggesting corrections for human approval and eventually performing routine corrections autonomously while flagging only unusual cases for manual intervention.

In some embodiments, the system can be configured to operate with enterprise resource planning (ERP) systems, customer relationship management (CRM) systems, and similar business management platforms. The server 116 can establish data connections with external ERP systems to synchronize inventory data regarding available materials stored in the materials database 308 and speaker driver components stored in the drivers database 310. When the three-dimensional printer 124 consumes materials during the mold production process, the system can transmit consumption data to the ERP system to update inventory levels and trigger automated reordering when stock falls below predetermined thresholds. The integration with CRM systems enables the server 116 to transmit customer order data, including user preferences, order history, and customization selections stored in the customer projects database 306, to centralized customer management platforms. This integration allows sales and support personnel to access comprehensive customer profiles that include earpiece customization history, enabling more personalized customer service interactions. The server interface 320 can receive customer data updates from the CRM system, such as updated contact information or communication preferences, and synchronize this information with the user files 318 stored on the electronic device 100. Additionally, the system can transmit production scheduling data to ERP systems to coordinate earpiece manufacturing with broader production planning and resource allocation processes.

In some embodiments, the functionality described as being performed by the server 116 can alternatively be performed locally by the electronic device 100. The electronic device 100 can include a processor and a non-transitory computer readable medium with logic stored thereon that, when executed by the processor, performs the earpiece customization operations described herein. In this configuration, the electronic device 100 can communicate directly with the three-dimensional printer 124 and the various databases, including the materials database 308, the drivers database 310, the pre-existing sizes database 304, and the customer projects database 306. The electronic device 100 can locally execute the matching algorithms, fit score calculations, and print parameter generation without requiring communication with the server 116. The databases can be stored locally on the electronic device 100 or can be accessed remotely by the electronic device 100 via the wireless network 110. This configuration allows for standalone operation of the system without requiring server connectivity, enabling users to complete the earpiece customization process in environments where network access to the server 116 may be limited or unavailable. In such embodiments, the electronic device 100 generates the print parameter data 316 locally and transmits the print parameter data 316 directly to the three-dimensional printer 124 to initiate mold production.

In some embodiments, the electronic device 100 can transmit the print parameter data 316 directly to a third-party three-dimensional printing service rather than to a three-dimensional printer 124 that is directly connected to the server 116 or operated by the user. The electronic device 100 can establish a communication link with an external printing service provider via the wireless network 110 and transmit the print parameter data 316 to the printing service. The printing service receives the print parameter data 316 and utilizes its own three-dimensional printing equipment to produce the earpiece mold according to the specifications contained in the print parameter data 316. Upon completion of the mold production, the printing service can create the finished earpiece by incorporating the selected materials and speaker drivers specified in the earpiece parameters and the speaker driver parameters. The completed earpiece can then be shipped directly to the user. This configuration allows users to obtain customized earpieces without requiring access to three-dimensional printing equipment or direct connectivity to a server-managed printer, as the printing service handles the manufacturing and fulfillment processes on behalf of the user.

In some embodiments, the server 116 can receive scan data and earpiece parameters from sources other than the electronic device 100 operated by the user. The server 116 can accept scan files uploaded from external sources, including third-party scanning services, audiologist offices, or hearing healthcare providers that utilize professional-grade ear scanning equipment. A user can obtain an ear scan from a professional scanning facility and subsequently upload the resulting scan file to the server 116 via the remote terminal 312 or through a web-based upload interface. The server 116 can process scan files in various standard file formats, enabling compatibility with scan data generated by different scanning devices and software platforms. This flexibility allows users who do not have access to an electronic device 100 with appropriate scanning capabilities to still utilize the earpiece customization system by obtaining scan data through alternative means. The server interface 320 can validate incoming scan files regardless of their source to ensure the data meets quality and completeness requirements before proceeding with the earpiece customization process.

The print parameter data 316 is transmitted to a three-dimensional printer 124, which uses the print parameter data 316 to create a customized earpiece or earpiece mold configured according to the user's ear dimensions and selected parameters. The three-dimensional printer 124 interprets the print parameter data 316 to produce a physical mold that corresponds precisely to the three-dimensional point map of the user's ear while accommodating the selected internal components and materials.

In some embodiments, the system can utilize the scanned parameter data 302 in conjunction with the pre-existing sizes database 304 to identify a best-fit earpiece from a set of pre-existing molds rather than creating an entirely custom mold. The server 116 compares the three-dimensional point map of the user's ear against the pre-existing set of earpiece dimensions stored in the pre-existing sizes database 304. The server interface 320 executes a matching algorithm that analyzes the dimensional characteristics of the user's ear scan, including ear canal diameter, depth, and outer ear contours, and correlates these measurements with the available pre-existing mold configurations.

The matching algorithm calculates a fit score for each pre-existing mold based on the degree of correspondence between the mold dimensions and the user's ear dimensions. The system identifies the pre-existing mold having the highest fit score as the recommended mold for the user. The server 116 then generates a recommendation that is transmitted to the electronic device 100 via data transmission 200, presenting the user with the suggested mold selection along with the calculated fit score and any relevant specifications. The user can elect to proceed with the suggested pre-existing mold or can choose to pursue a fully customized mold path. When the user accepts the recommended pre-existing mold, the system proceeds directly to mold production using the stored specifications from the pre-existing sizes database 304.

Alternatively, when the user determines that the suggested mold does not adequately meet their requirements, the electronic device 100 presents the user with an option to initiate a customization path. In the customization path, the server 116 utilizes the scanned parameter data 302 to generate a fully custom mold configuration that precisely matches the user's ear dimensions rather than relying on pre-existing templates. The user can also select a hybrid approach wherein the system uses a pre-existing mold as a baseline and applies modifications based on the differences between the pre-existing mold dimensions and the user's actual ear dimensions captured in the scan. The server interface 320 can present the user with a comparison of estimated production time, cost, and fit accuracy between the pre-existing mold option and the fully customized option, enabling the user to make an informed decision based on their priorities.

Upon user confirmation of the suggested mold, the system retrieves the corresponding mold specifications from the pre-existing sizes database 304 and generates print parameter data 316 based on the pre-existing mold configuration. The three-dimensional printer 124 then produces the earpiece according to the suggested mold dimensions. This approach can reduce manufacturing time and cost while still providing the user with an earpiece that closely matches their ear anatomy. The customer projects database 306 stores the mold selection and fit score data for future reference, enabling the system to refine recommendations for subsequent orders by the same user.

In some embodiments, the pre-existing sizes database 304 is dynamically modifiable based on data received by the system. The server 116 can add new mold configurations to the pre-existing sizes database 304 when the system identifies recurring ear dimension patterns that are not adequately represented by existing mold options. For example, when the matching algorithm repeatedly calculates low fit scores for a particular range of ear dimensions across multiple users, the server interface 320 can generate a new mold configuration that corresponds to those underserved dimensions and add the new configuration to the pre-existing sizes database 304.

In some embodiments, the pre-existing sizes database 304 may include separate sets of molds for right ears and left ears. The mold configurations for right ears and the mold configurations for left ears do not necessarily match symmetrically, as anatomical differences between a user's right ear and left ear may result in different optimal mold selections for each side. The server 116 may maintain distinct mold libraries for right ear configurations and left ear configurations, and the matching algorithm may independently select a best-fit mold from the appropriate library based on which ear is being scanned. This approach allows the system to accommodate users whose right and left ears have meaningfully different dimensional characteristics, providing improved fit accuracy for each ear without requiring that both ears conform to a single symmetric mold pairing.

The system can also subtract mold configurations from the pre-existing sizes database 304 based on usage data. When the server 116 determines that a particular pre-existing mold has not been selected or recommended over a threshold period of time, or when a mold configuration consistently receives low fit scores across the user population, the system can remove that mold from the database to streamline the matching process and reduce computational overhead.

The server 116 can modify existing mold configurations within the pre-existing sizes database 304 based on aggregated user feedback and fit data stored in the customer projects database 306. When users report fit issues or request adjustments to earpieces produced from a particular pre-existing mold, the server interface 320 analyzes the feedback data and adjusts the dimensional parameters of that mold configuration accordingly. The system can also refine mold dimensions based on statistical analysis of the differences between recommended molds and the actual custom molds that users ultimately select when they reject the pre-existing mold recommendations. In some embodiments, the system can analyze customer experience data including product returns, wherein when certain combinations of user parameters and pre-existing mold selections are associated with higher return rates, the server 116 can modify the pre-existing sizes database 304 to reduce this effect. The system can identify patterns where specific mold configurations consistently result in customer dissatisfaction or product returns and adjust or remove those configurations accordingly, thereby improving the overall performance and efficiency of the earpiece customization system.

In some embodiments, the modification of the pre-existing sizes database 304 can be performed automatically, semi-automatically with user suggestions, or manually. In an automatic mode, the server 116 continuously monitors fit score data and usage patterns across the user population and autonomously adds, removes, or modifies mold configurations without requiring intervention from a system administrator. The server interface 320 executes predefined rules that trigger database modifications when certain thresholds are met, such as when a minimum number of users exhibit similar underserved ear dimensions or when a mold configuration remains unused for a specified duration.

In a semi-automatic mode, the server 116 analyzes the aggregated data and generates suggestions for database modifications that are presented to a system administrator via the remote terminal 312. The suggestions can include recommendations to add new mold configurations based on identified gaps in the existing mold library, recommendations to remove underutilized molds, or recommendations to adjust dimensional parameters of existing molds based on user feedback trends. The system administrator reviews the suggestions and selects which modifications to implement, providing human oversight while leveraging the analytical capabilities of the system.

In a manual mode, a system administrator accesses the pre-existing sizes database 304 directly through the remote terminal 312 and makes modifications based on their own assessment of system performance and user needs. The administrator can add new mold configurations by inputting dimensional parameters, remove existing molds from the database, or edit the specifications of current mold configurations. The manual mode provides complete control over database contents and can be used in conjunction with reports generated by the server 116 that summarize fit score distributions, usage statistics, and user feedback data.

In some embodiments, the system can provide suggested speaker drivers based upon user data, user preferences, and the environment in which the earpiece will be used. The server 116 analyzes information stored in the customer projects database 306, including the user's previous earpiece orders, listening habits, and stated preferences, to generate driver recommendations tailored to the individual user. The server interface 320 retrieves driver specifications from the drivers database 310 and correlates these specifications with the user's profile data to identify speaker drivers that are likely to meet the user's requirements.

The system can receive environmental usage data from the user via the electronic device 100, wherein the user specifies the intended use environment for the earpiece. Environmental categories can include industrial settings with high ambient noise levels, office environments with moderate background noise, outdoor recreational activities, musical performance venues, or quiet indoor listening environments. The system may also receive performance criteria from the user, which can include application type such as studio recording or live performance, type of sound or music genre, venue characteristics, and other information relating to the environment and performance requirements. The server 116 processes the environmental usage data and performance criteria and applies selection criteria that match driver characteristics to the demands of the specified environment and intended application. For example, when a user indicates that the earpiece will be used in a high-noise industrial environment, the server interface 320 can recommend drivers with enhanced noise isolation properties or drivers optimized for voice communication clarity over a wide frequency response.

The system can also consider the physical dimensions of the user's ear as captured in the scanned parameter data 302 when generating driver suggestions. The server 116 cross-references the ear canal diameter and depth measurements from the three-dimensional point map with the physical dimensions of available drivers stored in the drivers database 310 to identify drivers that will fit within the customized earpiece mold while maintaining optimal acoustic performance. The server interface 320 filters out drivers that exceed the dimensional constraints imposed by the user's ear anatomy and ranks the remaining compatible drivers based on their suitability for the user's specified environment and preferences.

One or more different inventions may be described in the present application. Further, for one or more of the invention(s) described herein, numerous embodiments may be described in this patent application, and are presented for illustrative purposes only. The embodiments described are not intended to be limiting in any sense. One or more of the invention(s) may be widely applicable to numerous embodiments, as is readily apparent from the disclosure. These embodiments are described in sufficient detail to enable those skilled in the art to practice one or more of the invention(s), and it is to be understood that other embodiments may be utilized and that structural, logical, software, electrical and other changes may be made without departing from the scope of the one or more of the invention(s). Accordingly, those skilled in the art will recognize that the one or more of the invention(s) may be practiced with various modifications and alterations. Particular features of one or more of the invention(s) may be described with reference to one or more particular embodiments or figures that form a part of the present disclosure, and in which are shown, by way of illustration, specific embodiments of one or more of the invention(s). It should be understood, however, that such features are not limited to usage in the one or more particular embodiments or figures with reference to which they are described. The present disclosure is neither a literal description of all embodiments of one or more of the invention(s) nor a listing of features of one or more of the invention(s) that must be present in all embodiments.

Headings of sections provided in this patent application and the title of this patent application are for convenience only, and are not to be taken as limiting the disclosure in any way.

It is understood that the above descriptions and illustrations are intended to be illustrative and not restrictive. It is to be understood that changes and variations may be made without departing from the spirit or scope of the following claims. Other embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventor did not consider such subject matter to be part of the disclosed inventive subject matter.

What is claimed is:

1. A system for making a customized earpiece comprising:
a server adapted to provide service enabling data to a user, wherein the service enabling data is adapted to scan an ear;
an electronic device in communications with the server;
a three-dimensional printer in communications with the server;
a database of pre-existing molds in communications with the server, and,
a set of server computer readable instructions configured to:
receive a scan of the ear wherein the scan includes one or more dimensions of the ear,
receive an earpiece parameter according to the dimensions of the ear,
receive a speaker driver parameter representing a speaker driver,
select from the database of pre-existing molds a specific mold according to a fit score,
transmit the selected mold to the electronic device for verification from the user to use the mold, and upon receiving validation, transmit the print parameters to a manufacturing machine, wherein the manufacturing machine is adapted to create an earpiece.

2. The system of claim 1, wherein the set of server computer readable instructions is further configured to suggest to a server user a modification in the database of pre-existing molds for adding a new mold configuration when the fit score for a plurality of users fails to select below a threshold value for existing molds in the database.

3. The system of claim 1, wherein the set of server computer readable instructions is further configured to remove a mold from the database of pre-existing molds when the mold has not been selected over a threshold period of time.

4. The system of claim 1, wherein the fit score is calculated by comparing the dimensions of the ear from the scan against dimensional characteristics of each mold in the database of pre-existing molds.

5. The system of claim 1, wherein the earpiece parameter includes at least one of a material type, an earpiece style, and an intended use environment.

6. The system of claim 1, wherein the set of server computer readable instructions is further configured to suggest an alternative speaker driver based upon the dimensions of the ear and specified in the earpiece parameter.

7. A system for making a customized earpiece comprising:
a server adapted to provide service enabling data to a user, wherein the service enabling data is adapted to scan an ear;
an electronic device in communications with the server;
a three-dimensional printer in communications with the server; and,
a set of server computer readable instructions configured to:
receive a scan of the ear wherein the scan includes the dimensions of the ear,
receive an earpiece parameter according to the dimensions of the ear,
receive a speaker driver parameter representing a speaker driver,
associate the scan, the earpiece parameter, and the speaker driver parameter with each other;
generate a print parameter based on the scan, the earpiece parameter, and the speaker driver parameter; and,
transmit the print parameter to a manufacturing machine, wherein the manufacturing machine is adapted to create a mold according to the scan, the earpiece parameter, and the speaker driver parameter.

8. The system of claim 7, wherein a resulting earpiece is derived from the mold and includes a cavity for receiving a speaker driver.

9. The system of claim 7, wherein the manufacturing machine is a three-dimensional printer.

10. The system of claim 7, wherein the electronic device is adapted to utilize structured light scanning to capture the dimensions of the ear.

11. The system of claim 7, wherein the scan is provided by scanning computer readable instructions downloaded from the server to the electronic device.

12. The system of claim 7, wherein the earpiece parameter is received from a web application that can be accessed from the electronic device.

13. The system of claim 7, wherein the server, upon receiving the scan, the earpiece parameter and the speaker driver parameter is adapted to suggest an alternative speaker driver according to a usage data included in the earpiece parameter.

14. A system for making a customized earpiece comprising:
a server adapted to provide service enabling data to a user;
an electronic device in communications with the server;
a manufacturing machine in communications with the server; and,
a set of server computer readable instructions configured to:
receive a scan of an ear wherein the scan includes dimensions of the ear,
receive an earpiece parameter,
receive a speaker driver parameter representing a speaker driver, and
transmit data to the manufacturing machine, wherein the manufacturing machine is adapted to select an earpiece mold from a database of pre-existing molds according to a fit score or create an earpiece mold according to the scan, the earpiece parameter, and the speaker driver parameter.

15. The system of claim 14, wherein the fit score is calculated by comparing the dimensions of the ear from the scan against dimensional characteristics of each mold in the database of pre-existing molds.

16. The system of claim 14, wherein the set of server computer readable instructions is further configured to provide feedback to a user via the electronic device regarding quality and completeness of the scan.

17. The system of claim 14, wherein the earpiece parameter includes an intended use environment selected from industrial settings, office environments, outdoor recreational activities, musical performance venues, or quiet indoor listening environments.

18. The system of claim 14, wherein the set of server computer readable instructions is further configured to filter available speaker drivers based upon physical dimensions of the ear captured in the scan to identify drivers that fit within dimensional constraints of the earpiece mold.

19. A system for making a customized earpiece comprising:
a server adapted to provide to an electronic device in communications with the server;
a manufacturing machine in communications with the server; and,
a set of server computer readable instructions configured to:
receive a scan of an ear,
receive an earpiece parameter,
receive a speaker driver parameter,
associate the scan, the earpiece parameter, and the speaker driver parameter; and,
transmit data to the manufacturing machine to create an earpiece according to the scan, the earpiece parameter, and the speaker driver parameter.

20. The system of claim 19, wherein the earpiece parameter includes at least one of a material type, an earpiece style, color, and an intended use environment.
